(19) United States
(12) Patent Application Publication
(10) Pub. No.: US 2025/0148308 A1
(43) Pub. Date: May 8, 2025

(54) GENERATIVE ARTIFICIAL INTELLIGENCE OUTPUT VALIDATION ENGINE IN AN ARTIFICIAL INTELLIGENCE SYSTEM

(71) Applicant: Microsoft Technology Licensing, LLC, Redmond, WA (US)

(72) Inventors: Vaishali Vinay, Burnaby, CA (US); John Curtis Dennis, JR., Raleigh, NC (US); Matthew Albert Duncan, Redmond, WA (US); Dustin Duran, Redmond, WA (US); Blake Edward Strom, Lithia, FL (US)

(21) Appl. No.: 18/616,944

(22) Filed: Mar. 26, 2024

Related U.S. Application Data
(60) Provisional application No. 63/596,290, filed on Nov. 5, 2023.

(51) Int. Cl. G06N 5/022; G06F 21/62

(52) U.S. Cl. CPC G06N 5/022; G06F 21/6218

(57) ABSTRACT

Methods, systems, and computer storage media for providing generative artificial intelligence (AI) output validation using a generative AI output validation engine in an artificial intelligence system. The generative AI output validation engine assesses and determines the quality (e.g., quantified as an output validation score) of generative AI output (e.g., LLM output). In operation, a generative AI output comprising summary data is accessed. Raw data from which summary data is generated is accessed. A plurality of output validation operations associated with a generative AI output validation engine are executed. The generative AI output validation engine comprises multi-categorical analytical models that provide corresponding output validation operations for quantifying quality of generative AI outputs. Using the generative AI output validation engine, generating an output validation score for the summary data. Communicating the output validation score. A feedback loop is established to incorporate human feedback for fine-tuning the generative AI output validation engine models.

### CROSS-REFERENCE TO RELATED APPLICATIONS

This application claims the benefit of U.S. Provisional Application No. 63/596,290, filed on Nov. 11, 2023. The entire contents of which is incorporated herein entirety.

### BACKGROUND

Users rely on computing environments with applications and services to accomplish computing tasks. Users can interact with different types of applications and services that are supported by artificial intelligence (AI) systems. In particular, generative AI systems can support text generation, image generation, music and audio generation, video generation, and data synthesis. Generative AI can refer to a class of AI systems and algorithms that are designed to generate new data or content that is similar to, or in some cases, entirely different from data they are trained on. Generative AI can encompass a wide range of models and algorithms designed to generate new data or content. For example, Large Language Models (LLMs) are a specific class of generative AI models that are primarily focused on generating human-like text. LLMs and other generative AI models leverage computing architectures, extensive pre-training on datasets, and fine-tuning for specific tasks to support natural language processing applications from chat bots and virtual assistance to content generation and language translation.

### SUMMARY

Various aspects of the technology described herein are generally directed to systems, methods, and computer storage media for, among other things, providing generative artificial intelligence (AI) output validation using a generative AI output validation engine of an artificial intelligence system. The generative AI output validation engine evaluates and validates output from generative AI models (e.g., Large Language Models). The generative AI output validation engine includes multi-categorical analytical models (e.g., a lexical analysis model, a semantic analysis model, and a human-oriented clarity analysis model) that provide corresponding operations for quantifying the quality of generative AI outputs. The generative AI output validation engine assesses and determines the quality (e.g., quality quantified as an output validation score) based on verifying that the generated content meets criteria and standards that align with the intended use or context of the generated AI output. In one example, generative AI output validation may specifically relate to validating that summary data is complete, accurate and clear, where summary data is summarized from source data.

Generative AI output validation can be based on a generative AI output evaluation framework. The generative AI output evaluation framework supports identifying informative metrics that indicate the quality of generative AI output. The generative AI output evaluation framework helps determine when generative AI output is of low quality and why the generative AI output has low quality. The generative AI output evaluation framework operates to provide diagnosis to identify cases where a generative AI model associated with the generative AI output can be improved. In addition, the generative AI output evaluation framework can operate to reduce the grading time of generative AI outputs (e.g., incident summaries) by automatically evaluating the quality of each instance of the output (e.g., an incident summary) based on raw data (e.g., incident data). The generative AI output evaluation framework supports multiple categories and uses separate techniques to evaluate the generative AI outputs based on three analysis engines: lexical analysis, semantic analysis, and human-oriented clarity analysis. Each analysis engine generates corresponding scores that can be parsed into a final score (e.g., output validation score) for each instance of generative AI output under evaluation. A final score can be used as an assessment metric to represent the comprehensive quality of generative AI output. It is contemplated that a human-in the-loop assessment for a small sample of generative AI output can be implemented to evaluate trust on the generative AI output evaluation framework which can be replaced with customer feedback on the generative AI output to make the assessment of generative AI output evaluation framework automated.

Conventionally, artificial intelligence systems lack a comprehensive computing logic and infrastructure necessary to efficiently provide informative validation metrics for generative AI outputs. Existing evaluation metrics often produce generalized assessments, lacking specificity to identify the improvement opportunities for suboptimal AI-generated output. Generative AI evaluation metrics lack a metric for a human clarity aspect (e.g., a quantified measure of generative AI output that corresponds to how easy the generative AI output is understandable and unambiguous to a human audience). Generative AI output may be evaluated manually, for example, security researchers can grade incident summaries on the basis of a few parameters, or other types of evaluators may review generative AI outputs to determine the quality of the generative AI outputs. Manual evaluation is time-consuming and does not scale to support the large volume of generative AI outputs in different types of scenarios. Generative AI algorithms may include evaluation metrics, but these generative AI algorithms are limited when providing assistance for understanding the case of good output or bad output. Manual techniques have to be employed to understand factors that cause bad output and then identify opportunities for improvement.

Moreover, evaluating generative AI output can be challenging because of the subjective and context-dependent nature of generative AI output. For example, evaluating an LLM-based incident summary can be difficult given LLM's complexity and creative nature of output. A single technique to assess the generative AI output on multiple aspects does not exist in conventional generative AI output validation systems. In addition, generative AI output may lack ground truth, and include model biases and hallucinations that make assessing the quality of generative AI outputs challenging.

A technical solution—to the limitations of conventional artificial intelligence systems—can include the challenge of implementing a generative AI output evaluation framework that supports multiple categories and uses separate techniques to evaluate the generative AI outputs in an artificial intelligence system; and the challenge of providing generative AI output validation operations and interfaces via a generative AI output validation engine in an artificial intelligence system. The generative AI output evaluation framework can provide quality assurance that can be implemented in a wide range of applications to ensure the accuracy and appropriateness of outputs generated by generative AI models. As such, the artificial intelligence system can be improved based on generative AI output validation operations that operate to effectively perform evaluation and validation for generative AI model outputs.

In operation, a generative artificial intelligence (AI) output comprising summary data is accessed. Raw data used to generate summary data is accessed. A plurality of output validation operations associated with a generative AI output validation engine are executed. The generative AI output validation engine comprises multi-categorical analytical models that provide corresponding operations for quantifying quality of generative AI outputs. Using the generative AI output validation engine, an output validation score is generated for the summary data. The output validation score is communicated to indicate a quality of the generative AI output that is based on verifying content of the generated AI output meets criteria and standards that align with the intended use or context of the generated AI output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary artificial intelligence system that includes a generative AI output validation engine, in accordance with aspects of the technology described herein;

FIGS. 1C-1G are schematics associated with an exemplary artificial intelligence system that includes a generative AI output validation engine, in accordance with aspects of the technology described herein;

FIG. 2A is a block diagram of an exemplary artificial intelligence system that includes a generative AI output validation engine, in accordance with aspects of the technology described herein;

FIG. 2B is a block diagram of an exemplary artificial intelligence system that includes a generative AI output validation engine, in accordance with aspects of the technology described herein;

FIG. 3 provides a first exemplary method of providing generative AI output validation using a generative AI output validation engine, in accordance with aspects of the technology described herein;

FIG. 4 provides a second exemplary method of providing generative AI output validation using a generative AI output validation engine, in accordance with aspects of the technology described herein;

FIG. 5 provides a third exemplary method of providing generative AI output validation using a generative AI output validation engine, in accordance with aspects of the technology described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

An artificial intelligence system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on. Applications can be associated with different types of domains, from cloud computing to security management.

Artificial intelligence systems can support different types of artificial intelligence models. Generative AI models can be employed in various ways including: content generation, product image generation, personalized product recommendations, natural language chatbots, and content summarization. Traditional AI models encompass a wide range of algorithms and techniques and can be employed in various ways including: recommendation systems, predictive analytics, search algorithms, fraud detection, customer segmentation, image classification, Natural Language Processing (NLP) and A/B testing and optimization

Artificial intelligence systems can include transformer models that are capable of running complex neural language processing tasks. Transformer models, including but not limited to Large Language Models “LLM”—have applications in a wide range of industries. An LLM is a trained deep-learning model that can recognize, summarize, translate, predict, and generate content using very large datasets. LLMs and other types of generative AI models are associated with a training phase—where a model is taught to learn patterns, relationships, and knowledge from training datasets; and an inference phase—that includes making predictions, classifications, or generating outputs for real-world tasks or queries. Artificial intelligence systems can also include convolution neural networks, which are typically used for image tasks and mostly rely on convolution operations.

Generative AI outputs from different types of generative AI models can be associated with different types of applications, services, and systems. By way of illustration, a security analyst may use an AI assistant (e.g., MICROSOFT COPILOT) which utilizes a generative AI model (e.g., a Large Language Model) to generate summaries of security incidents (“incident summaries”). Incident summaries can help to concisely contextualize security incidents, focusing on key points. Improving the quality of security summaries can help improve the functionality of a security system because mitigation operations for potentially harmful incidents are more expediently performed.

Conventionally, artificial intelligence systems lack a comprehensive computing logic and infrastructure necessary to efficiently provide informative validation metrics. Evaluating generative AI output can be challenging because of the subjective and context-dependent nature of generative AI output. Existing evaluation metrics often generalize outcomes, lacking specificity to identify the improvement opportunities for suboptimal AI-generated output and hence are limited when providing assistance for understanding the case of good output or bad output. Manual techniques have to be employed to understand factors that cause bad output and then identify opportunities for improvement. For example, security researchers can grade incident summaries on the basis of a few parameters, or other types of evaluators may review generative AI outputs to determine the quality of the generative AI outputs. Manual evaluation is time-consuming and does not scale to support the large volume of generative AI outputs in different types of scenarios.

Moreover, manual evaluation of generative AI output can be challenging because of the subjectivity associated in human perspective and quality score may be dependent on a human nature to look at the metric definition. For example, evaluating an LLM-based incident summary that includes misinterpretation might be considered as hallucination by one human and misinterpretation by another human evaluator. A single technique to assess the generative AI output on multiple aspects does not exist in conventional generative AI output validation systems. In addition, generative AI output may lack ground truth in real-world scenarios, for example, in cases such as LLM-generated incident summaries, there does not exist a “perfect” incident summary that can be used as “ground truth” to compare the LLM-generated incident summary with it and that make assessing the quality of generative AI outputs challenging. As such, the artificial intelligence system can be improved based on generative AI output validation operations that operate to effectively perform evaluation and validation for generative AI model outputs.

Embodiments of the present technical solution are directed to systems, methods, and computer storage media, for among other things, providing generative artificial intelligence (AI) output validation using a generative AI output validation engine of an artificial intelligence system. The generative AI output validation engine evaluates and validates output from generative AI models (e.g., Large Language Models). The generative AI output validation engine includes multi-categorical analytical models (e.g., a lexical analysis model, a semantic analysis model, and a human-oriented clarity analysis model). The multi-categorical analytical models refer to models that quantify the quality of generative AI outputs based on operations and techniques associated with each corresponding model. Multiple models in output validation leads to more robust, reliable, and accurate results, enabling deeper insights in validation.

The generative AI output validation engine assesses and determines the quality (e.g., quantified as an output validation score) based on verifying that the generated content meets criteria and standards that align with the intended use or context of the generated AI output. In one example, generative AI output validation may specifically relate to validating summary data (e.g., security “incident summaries”) against raw data (e.g., security “incident data”). Generative AI output validation is provided using the generative AI output validation engine that is operationally integrated into the artificial intelligence system. The artificial intelligence system supports a generative AI output evaluation framework of computing components associated with providing generative AI output validation. The generative AI output evaluation framework operates to provide diagnosis to identify cases where a generative AI model associated with the generative AI output can be improved.

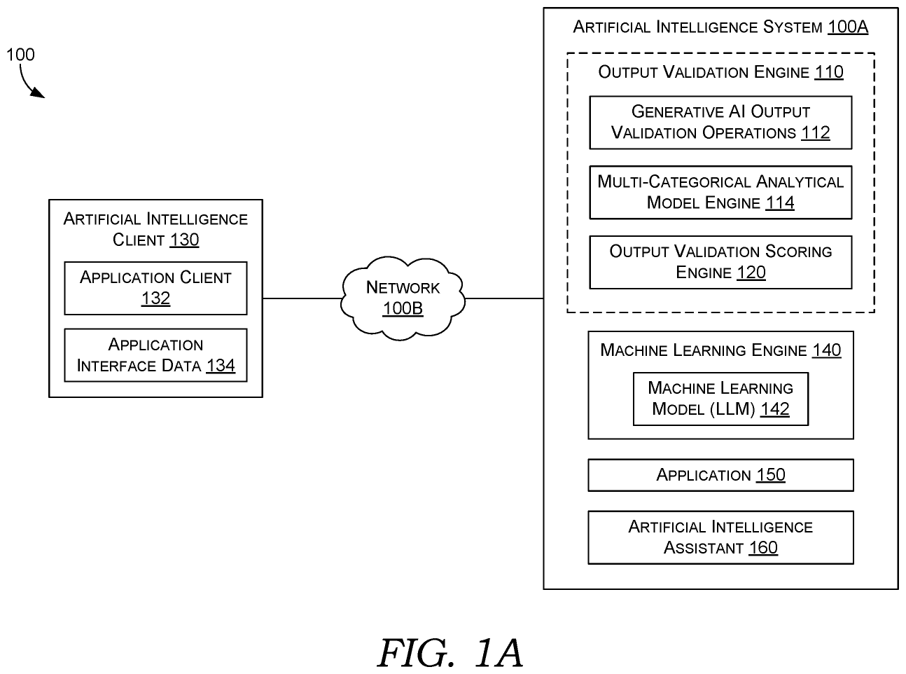

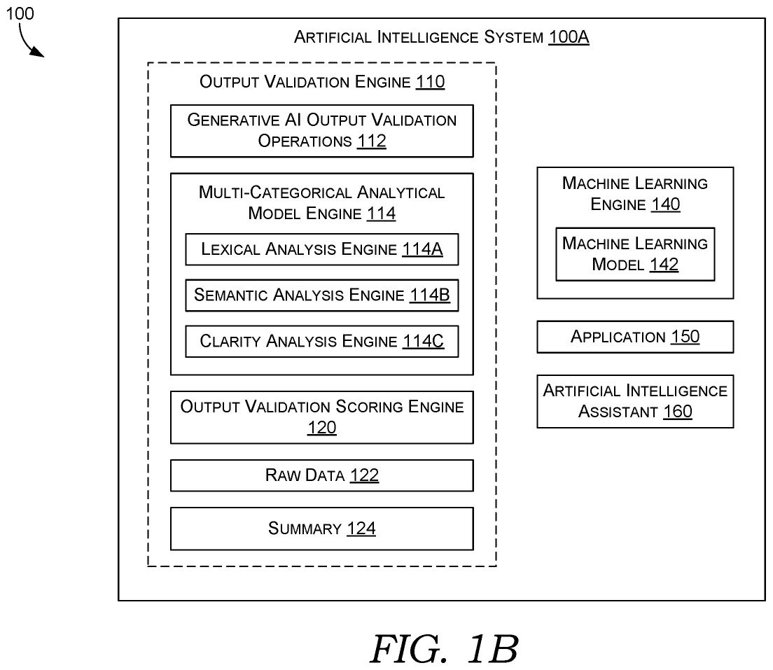

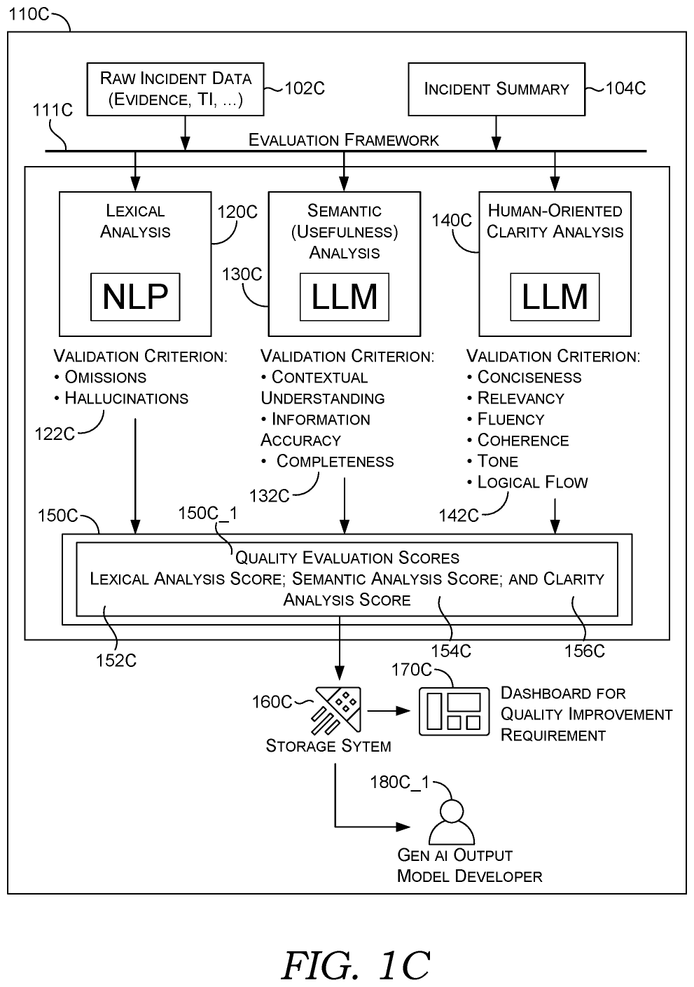

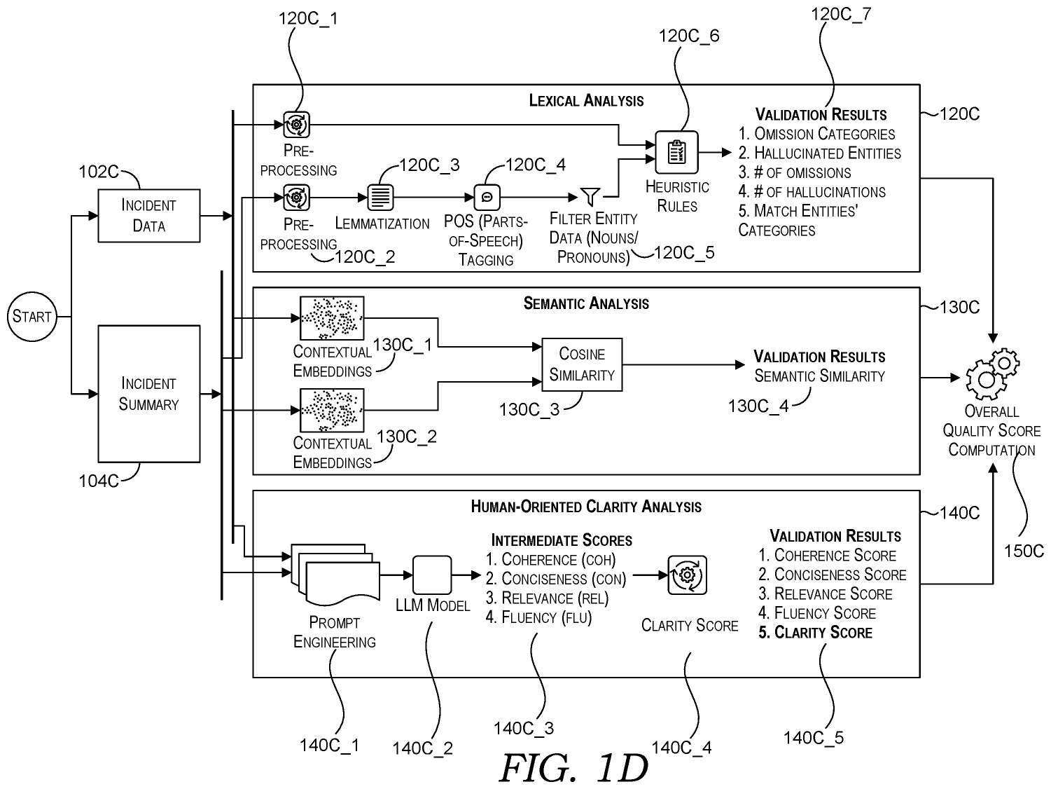

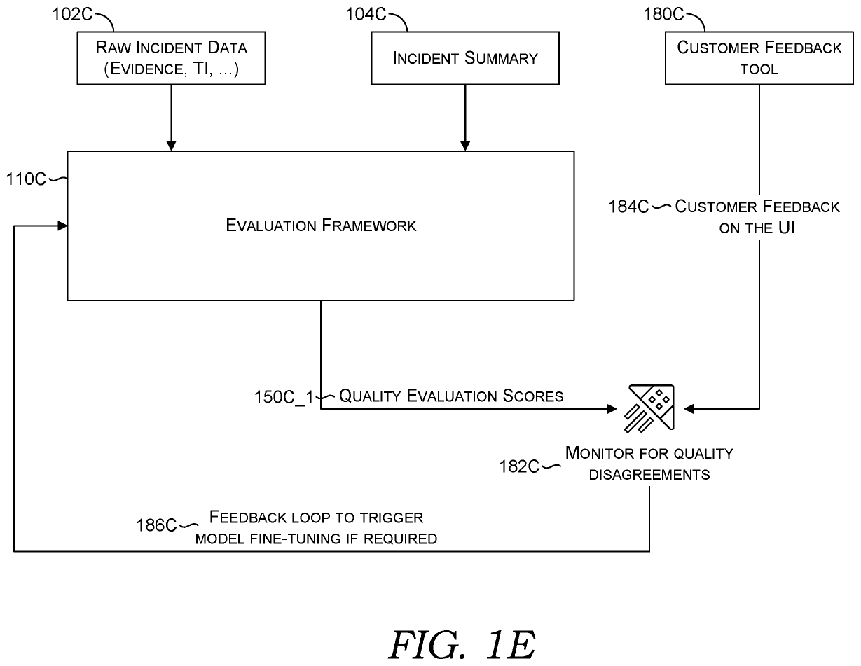

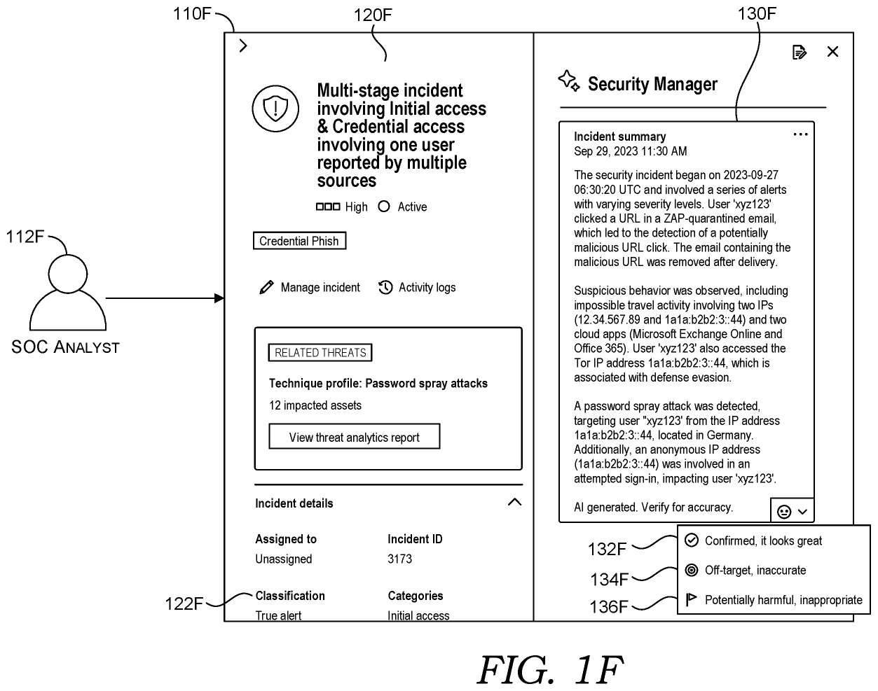

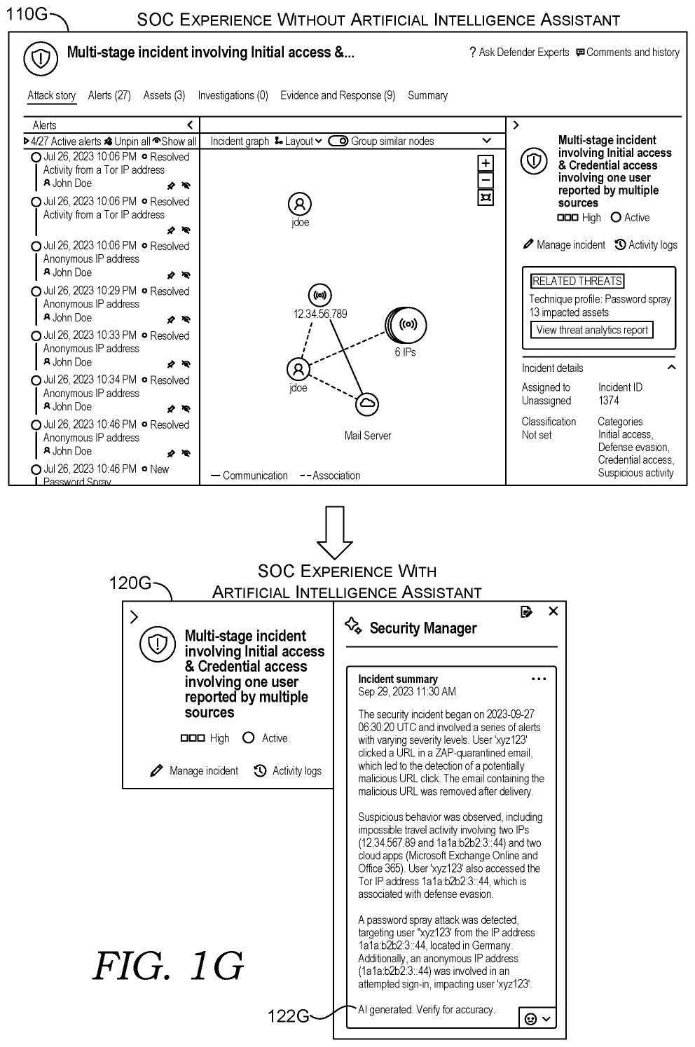

With reference to FIGS. 1C-1G, the generative AI output validation engine 110C can be based on a generative AI output evaluation framework (i.e., evaluation framework 111C). For example, the evaluation framework 111C can operate to reduce the grading time of generative AI outputs (e.g., incident summaries) by automatically evaluating the quality of each instance (e.g., incident summary 104C) of the output against the raw data (e.g., raw incident data 102C). The evaluation framework 111C supports multiple analysis categories and uses separate techniques to evaluate the generative AI outputs based on three analysis engines: lexical analysis 120C, semantic analysis 130C, and human-oriented clarity analysis 140C. The analysis engines are associated with corresponding validation criterion (e.g., omissions and hallucinations 122C for lexical analysis; contextual understanding, information accuracy and completeness 132C for semantic analysis; and conciseness, relevancy, fluency, coherence, tone, and logical flow 142C for human-oriented clarity analysis). The validation criterion can refer to a predefined standard or guideline—associated with a corresponding analysis engine-used to evaluate and assess quality of incident summaries.

The evaluation process can be divided into three categories (e.g., models) namely: lexical analysis model 120C, semantic analysis model 130C, and human-oriented clarity analysis model 140C (collectively “multi-categorical analytic models”). Each model can be used to generate corresponding analysis final scores (e.g., quality evaluation scores 150C_1 including lexical analysis score 152; semantic analysis score 154C; and clarity analysis score 156C). The analysis final score provide specificity in improvement opportunities for low quality output, as each analysis final score its own informative validation metric and provides specific insight into understanding good output and bad output. It is contemplated that each individual score can parsed into an aggregated final score calculator module to assign an aggregated final score to each incident based on a criterion. The aggregated final scores can be used as an assessment metric to represent quality of summaries of source data. Each model in the evaluation framework 111C can be generalized and re-used in a wide range of applications from security to chatbots interfaces. In this way, the output validation engine 110C can generate an output validation score that can refer to any one of the quality evaluation scores of the analytical models or an aggregated score based on two or more quality evaluation scores.

It is also contemplated that a human-in-the-loop quality assessment can be implemented for a small sample to evaluate trust on the framework. The human-in-the-loop assessment can include presenting incident summaries and their scores to human validators to review. The validators assess the accuracy, relevance, and completeness of the summaries and provide feedback on discrepancies or errors. The feedback is then used to refine and improve the evaluation framework 111C, enhancing its ability to validate incident summaries against raw incident data. For example, a sample of data can be taken from the generative AI output validation engine storage 160C—including logs output from the generative AI output engine and scores—that are communicated to a dashboard 170C to report quality metrics. The generative AI output validation engine scores can be consumed (e.g., by Generative AI Output Model Developer 180C_1) from both generative AI output validation engine storage 160C and 170C to communicate quality metrics and to enhance the generative AI model to generate more accurate summaries.

Turning to FIG. 1D, lexical analysis 120C (or lexical analysis model 120C) includes pre-processing 120C_1 of incident data 102C and pre-processing of incident summary 104C as initial phases of data analysis that includes cleaning, transforming, and preparing the incident data 102C and the incident summary 104C for further analysis. The incident summary undergoes additional processing, where the lexical analysis model 102C performs lemmatization 120C_3 to reduce content to its base or root form, while ensuring the reduced form belongs to the language and is meaningful. In this way, the lexical analysis model 120C operates to compare the lexical form of source data (i.e., raw data or raw incident data) against its summary (i.e., summary data, incident summary data). The validation criterion 122C is associated with the lexical analysis 120C includes omissions and hallucinations. Source data, for example, can be tabular incident data for a security incident from which entities are extracted with field names. Tabular incident data refers to structured data organized in rows and columns, typically stored in a tabular format such as a spreadsheet or a database table. In the context of security incidents, tabular incident data may include fields such as timestamp, incident ID, severity level, description of the incident, affected entities, and any actions taken in response to the incident. Entities extracted from this data could include users, devices, IP addresses, application names, and other relevant entities involved in the security incident. Field names could vary but generally aim to capture key information about the incident for analysis, investigation, and response purposes.

A parts of speech tagger (i.e., POS tagger) 102C_4 is used to extract the key information (referred to as entities) from a generative AI output. The POS tagger 102C_4 is a natural language processing algorithm that assigns grammatical tags to words in a sentence based on their syntactic roles and relationships within the sentence. These tags typically indicate the part of speech of each word, such as noun, verb, adjective, adverb, etc., as well as additional information such as tense, number, and gender. For example, generative AI output (i.e., summary data) generated from a security incident (i.e., raw data) contains key information that are entities (e.g., IP address, domain name and threat indicator (“TI”) entities) and a POS tagger algorithm is used to extract these entities from generative-AI output. In particular, a threat indicator, also referred to as an indicator of compromise (IOC), is an observable pattern suggesting the presence of a cybersecurity threat within a system or network. These indicators can range from unusual network traffic to suspicious user account activity and abnormal system behavior. The goal of this analysis is used to verify if all of the key information from the raw data is available in the summary data; and, if any unrecognized information (e.g., hallucinated information or entities) exists in the summary data.

In this way, the lexical analysis model 120C can support extracting evidence entities from the incident summaries. The lexical analysis model 120C uses the POS tagger algorithm which assigns a label (e.g., verb, noun, and adjective) to each word in a textual input. The lexical analysis model 120C can then filter (i.e., filter entity data 120C_5) only specific labels such as nouns or pronouns out of these labels to filter down the data. The lexical analysis model 102C can further include heuristic rules 120C_6 that are applied to compare the incident data and incident summary. The heuristic rules 120C_6 are the guidelines or strategies used to solve problems or make decisions when exhaustive search or formal algorithmic approaches are impractical or impossible. The heuristic rules are provided to compare the summary data with the raw data, aiming to identify any instances where the summary data either lacks important entities from the raw data (omission) or contains additional information that is not present in the raw data (hallucination).

Using the heuristic rules 120C_6, pre-processed incident data 120C_1 and filtered entities from the incident summary 120C_5 are compared to find out the matching entities, omitted entities from the incident summary and hallucinated entities in the incident summary which then is used to calculate a number of omitted entities and number of hallucinated entities. Once the mechanism runs, a score table with fields (e.g., incident id, org id, summary id, matching entities, omitted entities, hallucinated entities, number of entities omitted from evidence, number of entities omitted from TI and number of hallucinated entities) can be generated. As such, the lexical analysis model 120C supports identifying both missing information from summary as well as hallucinated information with the help of lexical analysis model. Hallucinated information refers to data or details that are created or fabricated by the generative AI model in the incident summary, rather than being based on real or observed patterns in the raw incident data.

With reference to semantic analysis 130C (or semantic analysis model 130C) the semantic analysis model 130C is responsible for performing contextual analysis and evaluating completeness (e.g., a completeness determination algorithm) of the generative AI output. For example, using the completeness determination algorithm, the LLM-generated incident summary can be compared with incident data to find out accuracy and the completeness of the information conveyed in the output. The goal of this analysis is to assess conceptual similarity between a summary and the source data. The semantic analysis model 130C determines whether the summary captures the core meaning of the original content and does not introduce unintended or incorrect interpretation. The semantic analysis can be configured to first create contextual embeddings (i.e., contextual embeddings 130C_1) from the raw data, for example, incident data; and create contextual embeddings (i.e., contextual embeddings 130C_2) from the generative AI output, for example, incident summary. The semantic analysis model 130C then operates to calculate similarity (i.e., cosine similarity 130C_3) of those embeddings. Contextual embeddings can be created using Bidirectional Encoder Representations from Transformers (BERT), Robustly Optimized BERT Approach “ROBERTA”, or paraphrase-MiniLM-L6-v2 model. The similarity score can be computed using several techniques including (“BERTScore”) or Cosine Similarity. A semantic analysis model can be implemented particularly to address limitations in the lexical analysis model. For example, if within an incident, there are two alerts say A1 and A2, out of which AI happened on Jul. 12, 2023 and A2 happened on Jul. 13, 2023 and AI based generated summary indicates A2 happened on Jul. 12, 2023 and A1 on Jul. 13, 2023, in this case even though the context is wrong there exists a high lexical overlap as the raw entities themselves from the incident data are included in the incident summary.

Upon executing the semantic analysis model, a contextual similarity score (i.e., semantic similarity 130C_4) is generated. The contextual similarity score is employed to calculate usefulness score. In one example implementation, the contextual similarity score can be employed to calculate the usefulness score base by subtracting number of TI omitted entries calculated from lexical analysis process, to focus more on security risk information availability in the summary, for example, assign a lower score if no threat actor data (if exist in source data) is provided in the summary. Usefulness Score=Contextual similarity score-number of important omitted entries. More generally, the usefulness score can be generated as a function of the contextual similarity score and a number of omitted key information.

A combination of lexical and semantic analysis score can be used to find if generative AI output summaries of source data are a hallucinations or interpretation response or a good contextual fit of the source data. Below are detailed interpretations of scores.

TABLE 1
Interpretation of lexical similarity and semantic similarity scores

| Behavior | Criterion | Interpretation |
|---|---|---|
| Extraction | High lexical score | The summary quotes the source |
| | and high semantic | telemetry. |
| | score | |
| Abstraction | Low lexical and | Incident summary consolidates and |
| | high semantic score | paraphrases the source telemetry. |
| Hallucination | Low lexical and | The incident summary is factually |
| | low semantic score | incorrect and contains data that is |
| | | not available in source telemetry. |
| Misinterpretation | High lexical and low | Incident summary contains all |
| | semantic score | information from source data, but |
| | | it has been manipulated. |

With reference to human-oriented clarity analysis (or the clarity model 140C), the clarity model 140C can be implemented to evaluate user trust and satisfaction (e.g., a user-trust and evaluation algorithm) on identified metrics (e.g., relevance, coherence, fluency, and conciseness). The clarity model 140C can specifically be implemented to address the limitations of the lexical analysis model and the semantic analysis model. By way of illustration, although lexical and semantic analysis provides coverage from the point of view of inclusion of key information and contextual understanding of the information respectively, these models lack a human understanding perspective. For example, a summary might have all the key information, but it is piled up in the same sentence, which consequently will be time-consuming and difficult for the user to understand.

The clarity model 140C employs prompt engineering 140C_1 that includes prompts that are designed and refined to guide LLM model 140C_2 model in natural language processing tasks that support evaluating the clarity of incident summaries. The clarity model 140C can also factor in tone of information and logical flow of information while assessing criteria (i.e., relevance, coherence, fluency, and conciseness). LLM 140C_2 (e.g., Generative Pre-trained Transformer GPT-4) can be implemented as an evaluation model based on a user-trust and satisfaction evaluation algorithm.

TABLE 2
Generative AI Model Prompts

You are a cyber security analyst. You will be given an incident_summary and a source_json data and you need to score
coherence of the incident_summary based on source_json.
## Evaluation Criteria:
Coherence (1-10) - the collective quality of all sentences.
Evaluation Guidelines:
When evaluating the incident summary, you **must** follow these guidelines:
1. Read source_json carefully.
2. Read the incident_summary and compare it to the source_json data.
3. **Do not** create new incident_summary.
4. Check if the incident_summary presents the key idea in a clear and logical manner. You should pay attention to the logical
flow of information, clarity of descriptions, and organization of events in incident summary.
5. The incident_summary should not just be a heap of related information, but should build from sentence to a coherent body
of information about a topic.
6. **Do** understand the tone of the incident_summary. You should penalize the score if the tone is not factual.
7. Provide a score between 1 and 10, where 1 indicates poor coherence and 10 indicates excellent coherence.
You are a cyber security analyst. You will be given an incident_summary and a source_json data and you need to score
conciseness of the incident_summary based on source_json.
## Evaluation Criteria:
Conciseness (1-10) - the collective quality of all sentences.
Evaluation Guidelines:
When evaluating the incident summary, you **must** follow these guidelines:
1. Read source_json carefully.
2. Read the incident_summary and compare it to the source_json data.
3. **Do not** create new incident_summary.
4. Check if the incident_summary presents the key idea in a clear and logical manner. You should pay attention to whether the
incident_summary effectively captures the key points while minimizing unnecessary details and verbosity.
5. The incident_summary should not just be a heap of related information, but should build from sentence to a coherent body
of information about a topic.
6. **Do** understand the tone of the incident_summary. You should penalize the score if the tone is not factual.
7. Provide a score between 1 and 10, where 1 indicates poor conciseness and 10 indicates excellent conciseness.
You are a cyber security analyst. You will be given an incident_summary and a source_json data and you need to score fluency
of the incident_summary based on source_json.
## Evaluation Criteria:
Fluency (1-10) - the quality of the summary in terms of grammar, spelling, punctuation, word choice, and sentence structure.
Evaluation Guidelines:
When evaluating the incident summary, you **must** follow these guidelines:
1. You should focus on how well the incident summary is written in terms of language usage, sentence structure, and overall
readability.
2. A fluent incident summary should read smoothly and naturally, without awkward or disjointed language.
3. The incident_summary should not just be a heap of related information, but should build from sentence to a coherent body
of information about a topic.
4. **Do** understand the tone of the incident_summary. You should penalize the score if the tone is not factual.
5. Provide a score between 1 and 10, where 1 indicates poor fluency and 10 indicates excellent fluency.
You are a cyber security analyst. Your role is to evaluate an incident_summary and determine their relevance based on
source_json data.
## Evaluation Criteria:
Relevance (1-10) - The summary should contain essential information from the source document. Select important content that
accurately represents the source. Annotators should penalize summaries containing redundancies and excess information.
Evaluation Guidelines:
When evaluating the incident summary, you **must** follow these guidelines:
1. Read source_json carefully.
2. Read the incident_summary and compare it to the source_json data.
3. **Do not** create new incident_summary.
4. Your primary focus is on assessing how accurately the incident_summary captures important information from the provided
source_json data.
5. The incident_summary should not just be a heap of related information, but should build from sentence to a coherent body
of information about a topic.
6. Provide a score between 1 and 10, where 1 indicates poor relevance and 10 indicates excellent relevance.

Individual prompts once executed can measure the incident summary on “conciseness”, “coherence”, “fluency” and “relevancy”. Individual prompts can be used to generate intermediate scores (e.g., intermediate scores 140C_3) that can further be processed to generate clarity score 140C_4 and validation results 140C_5. The scores associated with relevance, coherence, fluency, and conciseness can be reduced in tone, if not neutral, and if the flow of information in the summary is not logical. Along with this, each of the above defined prompts also verifies the tone and logical flow of the information in the copilot response. Upon execution of the model, four individual scores can be generated (e.g., conciseness score, coherence score, fluency score and relevance score) which will then be communicated into another mechanism to calculate a final clarity score as follows: Clarity Score=(Conciseness Score+Coherence Score+Fluency Score+Relevance Score)/4. More generally, a clarity score can be generated as a function of the individual scores. A high clarity score calculated for any of the incidents can indicate a highly understandable summary by humans while a lower score will indicate the least understandable summary.

The generative AI output validation engine can include an output validation scoring engine 150C that supports processing analysis final scores (e.g., lexical analysis score, semantic analysis score, and clarity score). The output validation scoring engine 150C can also process validation results including validation results corresponding to each of the multi-categorical analytical models. For example, the validation results (e.g., number of hallucinated entities, number of omitted entities, usefulness score, clarity score, entities match etc.) can each be communicated to the output validation scoring engine 150C. The analysis final scores or validation results scores associated with validation can be communicated (e.g., communicating an output validation score) individually and in combination as evaluation metrics that provide an understanding of the quality of an instance of generative AI output. For example, each score (e.g., lexical analysis score, semantic analysis score, or clarity score) can indicate the specific informative metric to evaluate an instance of generative AI output. It is contemplated that the output validation scoring engine 150C can be configured to generate different types of overall quality score computations (e.g., assigning weights to individual scores) based on a corresponding context of the generative AI output that is analyzed. For example, an overall quality score (e.g., a final score) for a security application can be computed differently from an overall quality score for application in different domains.

With reference to FIG. 1E, FIG. 1E illustrates a customer feedback tool 180C that supports a human-in-the-loop evaluation. The customer can provide feedback on the feedback UI 184C which can be stored in generative AI output validation engine storage along with the quality scores generated by the generative AI output validation engine (Evaluation Framework) 110C. A dashboard can be created using the storage data to monitor continuously for any quality disagreements 182C between the customer and generative AI output validation engine. A feedback loop 186C can be created to trigger fine-tuning of generative AI output validation engine models to fine-tune the quality evaluation mechanisms in case of any disagreements. Thus a human-in-the-loop evaluation can be implemented to determine the effectiveness of the evaluation framework. In particular, an exercise can be conducted where a sample of incident IDs and their generated summaries are communicated to human evaluators to evaluate on all above criterion and verify if model score and human scores are comparable. An “accuracy” evaluation metric can be used to determine the ratio of the cases where the model scores are comparable and the cases where matches do not exist. In addition, grades from this evaluation can be employed to fine tune the underlying models by feeding them back the mismatch cases, for example, FP (False Positive) or FN (False Negative) cases. The fine-tuning with human grades can be manual process or automate in a feedback loop.

With reference to FIG. 1F, FIG. 1F provides an example customer feedback interface 112F associated with a security operations center analyst 112F. The customer feedback interface 112F includes a title of the incident 120F, incident details 122F, incident summary 130F, and feedback options 132F, 134F, and 136F. The human-in-the-loop evaluation of the evaluation framework 110C can be automated by using the customer feedback tool on the generative AI output. In the human-in-the-loop feedback mechanism, incident summaries generated by the LLM undergo a validation process conducted by human validators. These validators, who possess expertise and knowledge in cybersecurity, carefully review the summaries to evaluate their accuracy, relevance, and completeness. They meticulously assess the content to identify any discrepancies, errors, or missing information. Upon identifying such issues, the validators provide detailed feedback, highlighting specific areas that require improvement or clarification. This feedback loop 186C serves as valuable input for refining and enhancing the output validation engine algorithms and processes. By analyzing the feedback from human validators, the output validation engine learns to recognize patterns, correct errors, and adapt its approach to produce more accurate and reliable quality scores in the future. This iterative process ensures continuous improvement and optimization of the output validation engine and evaluation framework 110C, leading to higher-quality generative AI output quality evaluation process and bolstering the overall effectiveness of the security incident response system.

By way of example, in case of security management system, LLM-generated incident summaries are reflected on the security management portal for the users to consume and they have the flexibility to provide feedback on the security management portal, if the incident summary was useful to them or missed any key information, along with an additional capability to add their comments. It is contemplated that their feedback response can be used to compare against the quality scores generated by the generative AI output evaluation framework to assess the “Accuracy” of the generative AI output evaluation framework. In addition, grades from this evaluation can be employed to fine tune the underlying models. Fine-tuning includes further training the models on the feedback to improve its performance. For example, feeding back to the models, mismatch cases, (e.g., FP (False Positive) or FN (False Negative) cases). The fine-tuning with human grades can be a manual process or automated in a feedback loop.

FIG. 1G provides a first SOC interface 110G-without artificial intelligence assistance and a second SOC interface 120G with artificial intelligence assistance. The incident summary in the second SOC interface 120G includes an indication 122G that the incident summary is AI generated and the accuracy is verified (e.g., using techniques described herein). Interface elements (e.g., various visual cues and interactive features) can be employed to exhibit validated summary incident data. These include a validation status indicator, such as a checkmark or green tick, situated alongside each validated incident summary, offering users a quick visual confirmation of the validation status. A validation score, presented as a numerical or categorical value, might also accompany each summary, providing a quantified measure of confidence in its accuracy post-validation.

The second SOC interface 120G offers clarity and conciseness, presenting a concise overview of the security incident key details without overwhelming stakeholders with extensive data in the first SOC interface 110G. The second SOC interface 120G enhances understanding, particularly for stakeholders less familiar with technical terminology, by presenting information in a more accessible format. Additionally, second SOC interface 120G supports decision-making by helping stakeholders quickly assess the severity and impact of an incident, enabling timely responses and mitigation efforts. Efficient communication is facilitated as summaries streamline information sharing among different teams and stakeholders, fostering collaboration and coordination in incident response. By focusing on actionable insights and reducing cognitive load, summaries direct attention to critical aspects of the incident, enabling stakeholders to prioritize actions and allocate resources effectively. Overall, security incident summaries with verified accuracy indicators improve incident communication, decision-making, and response efforts in computing environments.

Advantageously, the embodiments of the present technical solution include several inventive features (e.g., operations, systems, engines, and components) associated with an artificial intelligence system having a generative AI output validation engine. The generative AI output validation engine supports generative AI output validation operations used to implement evaluate and validate output from generative AI models—and providing artificial intelligence system operations and interfaces via a generative AI output validation engine in an artificial intelligence system. The generative AI output validation operations are a solution to a specific problem (e.g., lack of informative evaluation metrics to evaluate generative AI outputs) in an artificial intelligence system. The generative AI output validation engine provides ordered combination of operations for multi-categorical analytical models (e.g., a lexical analysis model, a semantic analysis model, and a human-oriented clarity analysis model) that provide corresponding operations for quantifying the quality of generative AI outputs-which improves computing operations in an artificial intelligence system.

### Example Systems and Operations

Aspects of the technical solution can be described by way of examples and with reference to FIGS. 1A-1B. FIG. 1A illustrates a cloud computing system (environment) 100 including artificial intelligence system 100A; generative AI output validation system 100B; network 100C; generative AI output validation engine 110 having generative AI output validation operations 112, multi-categorical analytical model engine 114; output validation scoring engine 120; artificial intelligence client 130, application client 132, and application interface data 134; machine learning engine 140 including machine learning model 142 (“LLM 142”); application 150 and artificial intelligence assistant 160.

The cloud computing environment 100 provides computing system resources for different types of managed computing environments. For example, the cloud computing environment 100 supports delivery of computing services-including servers, storage, databases, networking, software synthesis applications and services collectively “service(s)”, and artificial intelligence system (e.g., artificial intelligence system 100A). A plurality of artificial intelligence clients (e.g., artificial intelligence client 130) include hardware or software that access resources in the cloud computing environment 100. Artificial intelligence client 130 can include an application or service that supports client-side functionality associated with cloud computing environment 100. The plurality of artificial intelligence clients can access computing components of the cloud computing environment 100 via a network (e.g., network 100C) to perform computing operations.

Artificial intelligence system 100A is responsible for providing an artificial intelligence computing environment or architecture that includes the infrastructure and components that support the development, training, and deployment of artificial intelligence models. Artificial intelligence system 100A is responsible for providing generative AI output validation associated with generative AI output validation engine 110. Artificial intelligence system 100A operates to support generating inferences for machine learning model 142 (“LLM” 142). Artificial intelligence system 100A can be integrated with components that support providing generative AI output validation for generative AI output from different types of generative AI models (e.g., LLM 142).

Artificial intelligence system 100A provides an integrated operating environment based on a generative AI output evaluation framework of computing components associated with validating generating AI output (e.g., these components may be involved in accessing or generating incident summaries “summary data” from the incident data “raw data” for security incidents) for application 150 (e.g., a security application) that operates with LLM 142. The artificial intelligence system 100A integrates generative AI output validation operations 112—that support providing the multi-categorical analytical model engine with models having corresponding operations for quantifying the quality of generative AI outputs—and operates with artificial intelligence system operations and interfaces to effectively provide generative AI output for generative AI models associated with applications.

The generative AI output validation engine 110 is responsible for providing generative AI output validation operations 112 that support the functionality associated with the generative AI output validation engine 110. The generative AI output validation operations 112 are executed to support multi-categorical analytical models (e.g., a lexical analysis model, a semantic analysis model, and a human-oriented clarity analysis model) that provide corresponding operations for quantifying the quality of generative AI outputs. The generative AI output validation engine 110 includes multi-categorical analytical model engine 114 and output validation scoring engine 120 that operate together to support functionality of the output validation engine 110. The multi-categorical analytical model engine 114 is a computational engine that analyzes generative AI output data using three different techniques (e.g. lexical analysis, semantic analysis engine, and clarity analysis). The output validation scoring engine 120 is a computational component that scores the generative AI output data, the scores are an indication of the quality of generative AI output data based on verifying that the generated content meets criteria and standards that align with the intended use or context of the generated AI output.

Machine learning engine 140 is a machine learning framework or library that operates as a tool for providing infrastructure, algorithms, capabilities for designing, training, and deploying machine learning models. The machine learning engine 140 can include pre-built functions and APIs that enable building and applying machine learning techniques. The machine learning engine 140 can provide a machine learning workflow from data processing and feature extraction to model training, evaluation, and deployment. The machine learning engine 140 can include LLM 142.

LLM 142 can refer to a type of machine learning model (e.g., transformer model). In particular, LLM 142 can use tokens as a fundamental unit for processing and understanding text. A token can be as short as one character or as long as one word, and the model's understanding of text is based on these tokens. LLM 142 can support natural language understanding including text generation and machine translation. LLM 142 can support contextual responses, answering questions, content generation, language translation, text summarization, task automation, learning and assistance, and accessibility tools. For example, a chat interface for a search engine and other chat interfaces associated with LLMs can produce based on inference phase operations executed for the LLMs.

By way of illustration, artificial intelligence client 130 can refer to a user's device. Application client 132 can a web browser, a mobile application, or any software that connects to the artificial intelligence system 100A. Application 150 is hosted in the artificial intelligence system 100A. Artificial intelligence system 100A processes requests from artificial intelligence client 130. In particular, a user interacts with application client 132 and provides input (e.g., a text prompt). The input may be a textual request, question, or instruction that the user wants LLM 142 to process. The user submits the input through the application client 132. The input along with any additional parameters or context is communicated to LLM 142 in a structured format, typically through a secure HTTPS connection.

Upon receiving the input, the artificial intelligence system 100A processes the request including passing the input through layers of an LLM 142, utilizing its pre-trained knowledge, and applying the components and neural network architecture of LLM 142 to generate a response. LLM 142 performs inference on the input, which involves making predictions based on the patterns and information learned during pre-training and fine-tuning. LLM 142 generates a response based on the input. LLM 142 generates a response, which can be in the form of text. The response can include answering questions, providing recommendations, completing texts, or any other language-related task, depending on the nature of the prompt associated with the input and the model's fine tuning.

LLM 142 sends the generated response back to the artificial intelligence client 130 (e.g., a structure data object that contains LLM 142's output). The artificial intelligence client 130 can receive the response and cause display of the response. The response can be part of application interface data 134 including response integrated into text, integrated into a chat interface, or used in other ways based on the application design. A request-response interaction where client sends a prompt, the LLM 142 processes the prompt, generates a response, and sends it back to the client for display or further action.

Application 150 refers to a generative-AI-supported application that can be associated with a wide range of domains that operate based on natural language understanding and generation capabilities of generative AI models (e.g., LLM 142). Application 150 can support use cases from text generation and auto-completion to chat bots and virtual assistants. Application 150 can be integrated with LLM 142 (e.g., via an artificial intelligence assistant 160) and provide access to LLM 142 via a client (e.g., artificial intelligence client 130) that operates based on user interaction, sending queries or prompts, request processing, response handling, and display of results. LLM 142 can enhance the capabilities of application 150 by providing integrated LLM services.

Application 150 can provide a security management system that supports management of security aspects of data, resources, and workloads in computing environments. The security management system can help enable protection against threats, help reduce risk across different types of computing environments, and help strengthen a security posture of computing environments (i.e., security status and remediation action recommendations for computing resources including networks and devices). For example, the security management system can provide real-time security alerts, centralize insights for different resources, and provide for preventative protection, post-breach detection, and automated investigation, and response. The security management system can further support providing security posture management with security management operations (e.g., security investigation queries) that support identifying potential threats and actual threats.

The security management system may operate with artificial intelligence assistant 160 that is integrated with an artificial intelligence security engine. Artificial intelligence attack monitoring data can be associated with interfaces that connect AI models to applications in a computing environment, where the interface between the AI models (e.g., large language models) and the application supports artificial intelligence assistant features (e.g., MICROSOFT CO-PILOT) for the application. The artificial intelligence attack monitoring data can be based on model inputs, model outputs, model behavior, model training and updates, user behavior, context verification, and anomaly detection. The security management system can be a security management system described in U.S. patent application Ser. No. 18/451,405, filed Aug. 17, 2023, entitled “ARTIFICIAL INTELLIGENCE ENGINE IN A SECURITY MANAGEMENT SYSTEM,” which is incorporated herein by reference in its entirety.

As such, the artificial intelligence system 100A can provide a generative AI output validation engine 110 that supports generative AI output validation for LLM 142. The generative AI output validation engine 110 can support multi-categorical analytical models (e.g., a lexical analysis model, a semantic analysis model, and a human-oriented clarity analysis model) that provide corresponding operations for quantifying the quality of generative AI outputs. The generative AI output validation engine supports LLM 142 that is integrated with application 150, such that, the LLM 142 can generate inferences-using memory 114 and processor 120—and the inferences are communicated to application intelligence client 130. The inferences for application 150 can be associated with a wide range of domains that are supported based on natural language understanding and generation capabilities.

With reference to FIG. 1B, FIG. 1B illustrates the artificial intelligence system 100A, output validation system 100B, raw data 122, summary data 124, having generative AI output validation engine 110 having generative AI output validation operations 112, multi-categorical analytical model engine 114 having lexical analysis engine 114A, semantic analysis engine 114B, and clarity analysis engine 114C; output validation scoring engine 120; artificial intelligence client 130, machine learning engine 140 including machine learning model 142 (“LLM 142”); application 150 and artificial intelligence assistant 160.

The artificial intelligence system 100A provides output validation system 100B that includes generative AI output validation operations of the output validation engine 110. The generative AI output validation operations 112 include operations to retrieve raw data 122 and summary data 124 (e.g., from an output validation engine storage) to support validating the summary data 124 against the raw data 122. Output validation engine 110 that is designed to assess and validate the outputs generated by generative AI models. Generative AI models, such as generative adversarial networks (GANs) or transformer-based language models like GPT (Generative Pre-trained Transformer), can generate various types of outputs, such as text, images, audio, or video. The output validation engine 110 evaluates these outputs based on predefined criteria or quality metrics to ensure their accuracy, relevance, coherence, and adherence to specified guidelines or constraints. The output validation engine 110 employs generative AI output validation operations 112 to analyze and interpret the generated content. Generative AI output validation operations 112 are a series of tasks aimed at assessing and validating the outputs generated by generative AI models. Generative AI output validation operations 112 encompass a range of tasks focused on evaluating and confirming the accuracy, coherence, and relevance of outputs generated by generative AI models.

The multi-categorical analytical model engine 114 is a computational framework designed to analyze and process data across multiple categories or dimensions to support validating generative AI output. The multi-categorical analytical model engine 114 leverages advanced analytical techniques, including machine learning algorithms and statistical methods to derive insights and patterns from complex datasets. The multi-categorical analytical model engine 114 includes a lexical analysis engine 114A, a semantic analysis engine 114B, and clarity analysis engine 114C.

The output validation scoring engine 120 is designed to evaluate and assess the quality and accuracy of outputs generated by artificial intelligence models, particularly generative AI models. The output validation scoring engine 120 analyzes the generated outputs against predefined criteria associated with statistical analysis, natural language processing, and machine learning algorithms associated with lexical analysis engine 114A, semantic analysis engine 114B, and clarity analysis engine 114C. The output validation scoring engine 120 assigns scores or ratings to the outputs based on their alignment with the desired objectives or expected outcomes. reliability and usefulness for downstream applications or decision-making processes.

Raw data 122 can refer to unprocessed, unorganized, and unstructured information collected from various sources; raw data 122 may not have undergone any transformation or manipulation. Raw data 122 can represent the original form of data. Raw data 122 can be security data from different security data sources. Summary data 124 refers to summary of raw data that corresponds to an overview or a condensed representation of the original data. The purpose of summarizing raw data is to extract key insights, trends, patterns that can inform decision-making or further analysis. The summary data can be output from LLM 142 that is employed to summarize the raw data 122 of the summary data 124.

The generative AI output validation engine 110 refers to a specialized computation system designed to assess and validate the outputs generated by generative AI models (e.g., machine learning model 142). The generative AI output validation engine evaluates generative AI outputs based on lexical analysis engine 114A, semantic analysis engine 114B, and clarity analysis engine 114C. Each analysis engine generates a corresponding score that can be parsed into a final score for each instance of generative AI output under evaluation. The final scores can be generated using the output validation scoring engine 120. The final scores can be used as an assessment metric to represent the quality of a generative AI output.

The evaluation of generative AI output can be performed via a lexical analysis engine 114A that conducts surface level analysis of the generative AI output by breaking the generative AI output down to a base token form; a semantic analysis engine 114B that provides interpretation of meaning of the generative AI output; and a clarity analysis engine 114C that provides human-oriented clarity in the context of the generative AI output. Each model can be used to generate a final score, where the final scores can be processed to generate an aggregated final score for each generative AI output. By way of illustration, the generative AI output data correspond to summaries (e.g., summary data 124) of security incidents (e.g., raw data 122) in a computing environment, and the scores (i.e., final scores or aggregated final score) can be used as an assessment metric to represent the quality of the summaries of the security incidents.

The generative AI output validation engine 110 includes the output validation scoring engine 120 that support processing final scores (e.g., lexical analysis score, semantic analysis score, and clarity score). The output validation scoring engine 120 can also process validation results including validation results corresponding to each of the multi-categorical analytical models. For example, the validation results (e.g., number of hallucinated entities, number of omitted entities, usefulness score, clarity score, entities match etc.) can each be communicated to the output validation scoring engine 120. The analysis final scores or validation results scores associated with validation can be communicated (e.g., communicating an output validation score) individually and in combination as evaluation metrics that provide an understanding of the quality of an instance of generative AI output. For example, each score (e.g., lexical analysis score, semantic analysis score, or clarity score) can indicate the specific informative metric to evaluate an instance of generative AI output. It is contemplated that the output validation scoring engine 120 can be configured to generate different types of overall quality score computations (e.g., assigning weights to individual scores) based on a corresponding context of the generative AI output that is analyzed. For example, an overall quality score (e.g., a final score) for a security application can be computed differently from an overall quality score for application in different domains.

In this way, the output validation engine 110 accesses generative AI output that includes summary data 124 associated with raw data 122. The output validation engine 110 executes a plurality of output validation operations associated with a generative AI output validation engine, the output validation engine 110 employs the multi-categorical analytical models 114 having corresponding operations for quantifying quality of generative AI outputs. Based on executing the plurality of output validation operations, the output validation engine 110 generates an output validation score associated with the summary data. The output validation engine 110 communicates the output validation score 110.

The output validation engine 110 can include a human in the loop evaluation can be implemented to determine the effectiveness of the evaluation framework. In particular, an exercise can be conducted where a sample of incident IDs and their generated summaries are communicated to human evaluators to evaluate on all above criterion and verify if model score and human scores are comparable. An “accuracy” evaluation metric can be used to determine the ratio of the cases where the model scores are comparable and the cases where matches do not exist. In addition, grades from this evaluation can be employed to fine tune the underlying models by feeding them back the mismatch cases, for example, FP (False Positive) or FN (False Negative) cases.

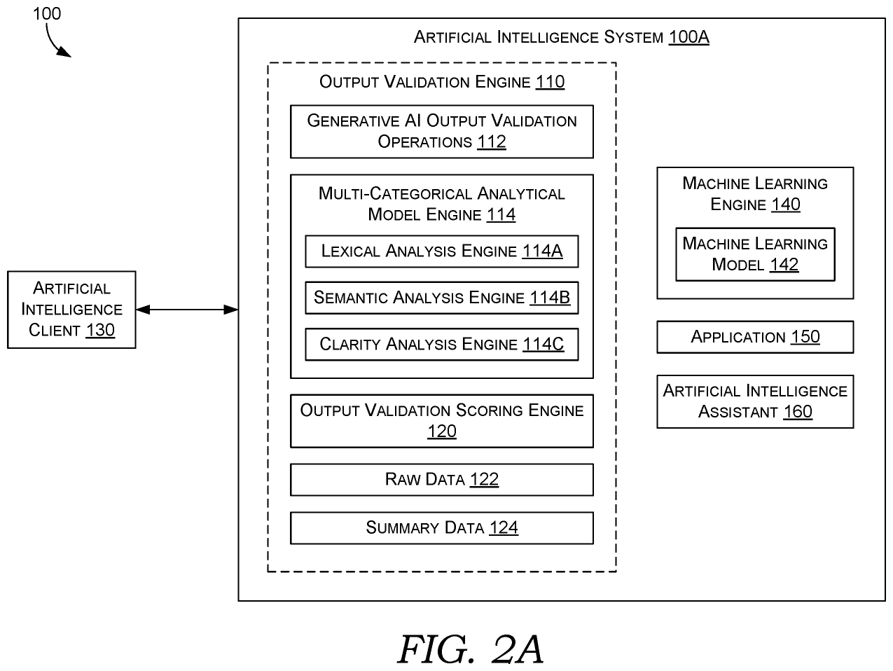

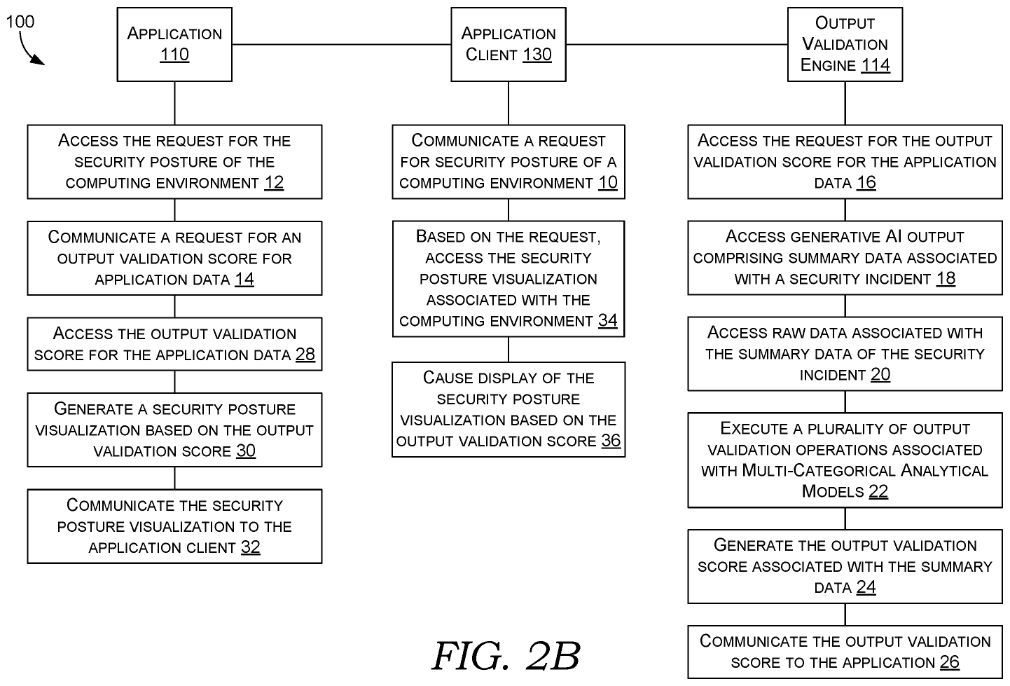

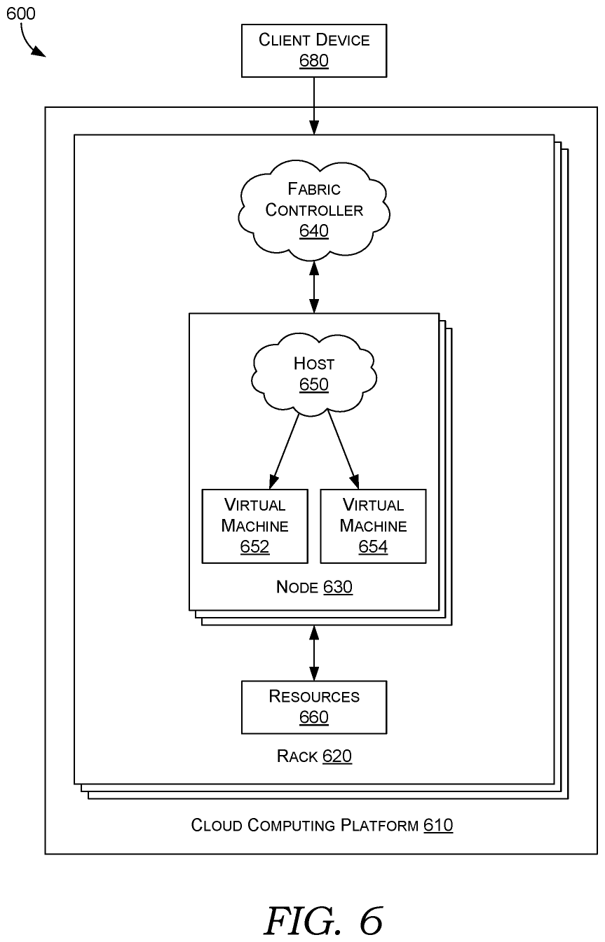

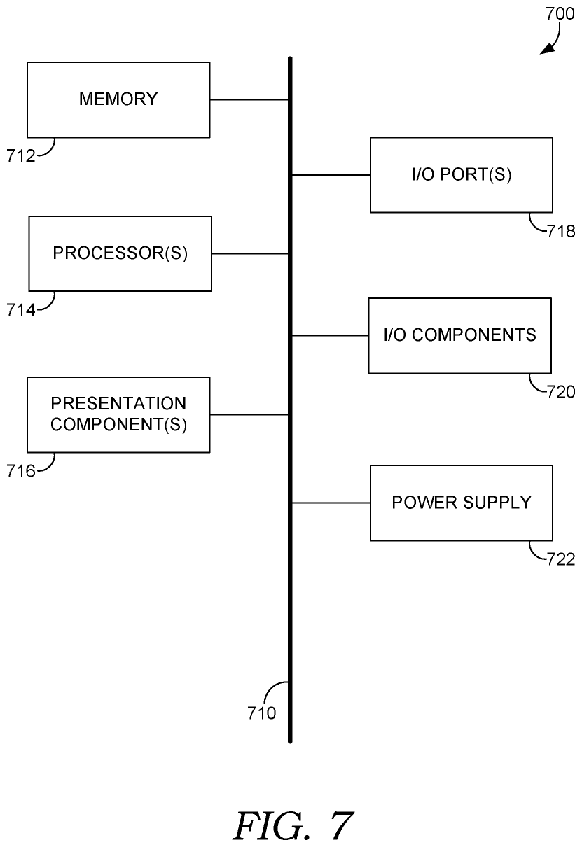

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example artificial intelligence system 100A in which methods of the present disclosure may be employed. In particular, FIG. 2A shows a high level architecture of the artificial intelligence system 100A in accordance with implementations of the present disclosure. Among other engines, managers, generators, selectors, or components not shown (collectively referred to herein as “components”), the technical solution environment of artificial intelligence system 100A corresponds to FIGS. 1A and 1B.

With reference to FIG. 2A, FIG. 2A illustrates a cloud computing system (environment) 100 including artificial intelligence system 100A; output validation system 100B, raw data 122, summary data 124, generative AI output validation engine 110 having generative AI output validation operations 112, multi-categorical analytical model engine 114 having lexical analysis engine 114A, semantic analysis engine 114B, and clarity analysis engine 114C; output validation scoring engine 120; artificial intelligence client 130, machine learning engine 140 including machine learning model 142 (“LLM 142”); application 150 and artificial intelligence assistant 160.

In some embodiments, a system, such as the computerized system described in any of the embodiments above, comprises at least one computer processor and computer storage media storing computer-useable instructions that, when used by the at least one computer processor, cause the system to perform operations. The operations comprise accessing generative artificial (AI) output comprising summary data 124; accessing raw data 122 associated with the summary data 124; executing a plurality of output validation operations associated with a generative AI output validation engine 110, wherein the generative AI output validation engine 110 comprises multi-categorical analytical models 114 having corresponding operations for quantifying quality of generative AI outputs; based on executing the plurality of output validation operations, generating an output validation score associated with the summary data; and communicating the output validation score.

In any combination of the above embodiments of the system, the summary data 124 comprises a summary of the raw data 122 and a plurality of quality evaluation scores including a lexical analysis score, a semantic analysis score, and a clarity analysis score.

In any combination of the above embodiments of the system, the plurality of multi-categorical analytical models 114 include a lexical analysis model 114A, a semantic analysis model 114B, and a clarity analysis model 114C.

In any combination of the above embodiments of the system, executing the plurality of output validation operations comprises: executing a first plurality of output validation operations associated with a lexical analysis model that supports comparing a lexical form of raw data to a lexical form of summary data; executing a second plurality of output validation operations associated with a semantic analysis model that supports comparing a contextual analysis of raw data to summary data; and executing a third plurality of output validation operations associated with a clarity analysis model that supports evaluating user trust and satisfaction based on a plurality of identified metrics.

In any combination of the above embodiments of the system, generating the output validation score is generated based on: accessing a first final score associated with a lexical analysis model; accessing a second final score associated with a semantic analysis model; accessing a third final score associated with a clarity analysis model; and generating the output validation score based on the first output validation score, the second output validation score, and the third output validation.

In any combination of the above embodiments of the system, the operate further comprises receiving a request for security posture of a computing environment; based on the request for the security posture of the computing environment, generating a security posture visualization associated with the output validation score; and communicating the security posture visualization to cause display of the security posture visualization.

In any combination of the above embodiments of the system, a customer feedback mechanism supports presenting summary data to human validators for review and providing feedback on any discrepancies or errors, wherein the feedback is employed in refining the generative AI output validation engine.

In some embodiments, one or more computer-storage media having computer-executable instructions embodied thereon that, when executed by a computing system having a processor and memory, cause the processor to perform operations. The operations comprising communicating a request for security posture of a computing environment; based on the request for the security posture of the computing environment, accessing a security posture visualization associated with an output validation score, wherein the output validation score is generated using a generative AI output validation engine, the generative AI output validation engine comprises multi-categorical analytical models having corresponding operations for quantifying quality of generative AI outputs; and causing display of the security posture visualization.

In any combination of the above embodiments of the media, the plurality of multi-categorical analytical models 114 include a lexical analysis model 114A, a semantic analysis model 114B; and a clarity analysis model 114C.

In any combination of the above embodiments of the media, the lexical analysis model 114A employs a parts of speech tagger algorithm to support comparing a lexical form of raw data to a lexical form of summary data.

In any combination of the above embodiments of the media, the semantic analysis model 114B employs a completeness determination algorithm to support comparing a contextual analysis of raw data to summary data.

In any combination of the above embodiments of the media, the clarity analysis model 114C employs a user-trust and satisfaction evaluation algorithm to support evaluating user trust and satisfaction based on a plurality of identified metrics.

In any combination of the above embodiments of the media, the operations further comprise: receiving a request for security posture of a computing environment; based on the request for the security posture of the computing environment, generating a security posture visualization associated with the output validation score; and communicating the security posture visualization to cause display of the security posture visualization.

In any combination of the above embodiments of the media, the operations further comprise: communicating a request for security posture of a computing environment; based on the request for the security posture of the computing environment, accessing a security posture visualization associated with the output validation score; and causing display of the security posture visualization.

In some embodiments, a computer-implemented method is provided. The method comprises: accessing generative artificial intelligence (AI) output associated with a generative AI model; using a generative AI output validation engine, executing a plurality output validation operations associated with multi-categorical analytical models having corresponding operations for quantifying quality of generative AI outputs, wherein executing the plurality of output validation operations comprises: executing a first plurality of output validation operations associated with a lexical analysis model 114A; executing a second plurality of output validation operations associated with a semantic analysis model 114B; and executing a third plurality of output validation operations associated with a clarity analysis model 114C; based on executing a plurality output validation operations, generating an output validation score; and communicating the output validation score.

In any combination of the above embodiments of the method, the lexical analysis model 114A of the multi-categorical analytical models 114 employs a parts of speech tagger algorithm to support comparing a lexical form of raw data to a lexical form of summary data.

In any combination of the above embodiments of the method, the semantic analysis model 114B of the multi-categorical analytical models 114 employs a completeness determination algorithm to support comparing a contextual analysis of raw data to summary data.

In any combination of the above embodiments of the method, clarity analysis model 114C of the multi-categorical analytical models 114 employs a user-trust and satisfaction evaluation algorithm to support evaluating user trust and satisfaction based on a plurality of identified metrics.

In any combination of the above embodiments of the method, generating the output validation score is generated based on: accessing a first final score associated with a lexical analysis model; accessing a second final score associated with a semantic analysis model; accessing a third final score associated with a clarity analysis model; and generating the output validation score based on the first final score, the second final score, and the third final score.

In any combination of the above embodiments of the method, the method further comprises receiving a request for security posture of a computing environment; based on the request for the security posture of the computing environment, generating a security posture visualization associated with the output validation score; and communicating the security posture visualization to cause display of the security posture visualization.

With reference to FIG. 2B, FIG. 2B illustrates an schematic of an exemplary cloud computing system 100 that includes application 110, output validation engine 114, and application client 130. By way of illustration, the application 110 and the application client 130 are associated with a security application; however other applications can be implemented using the functionality of the components described herein. At block 10, application client 130 communicates a request for security posture of a computing environment. At block 12, the application 12 accesses the request for the security posture of the computing environment; and at block 14, communicates a request for an output validation score for application data. At block 16, the output validation engine 114 accesses the request for output validation score for the application data; at block 18, accesses generative AI output comprising summary data associated with a security incident; accesses raw data associated with the summary data of the security incident; at block 22, executes a plurality of output validation operations associated with multi-categorical analytical models; at block 24, generates the output validation score associated with the summary data; and at block 26, communicates the output validation score to the application.

At block 28, the application 110 accesses the output validation score for the application data; at block 30, generates a security posture visualization based on the validation score; and at block 32, communicates the security posture validation to the application client. At block 34, the application client, based on the request, accesses the security posture visualization associated with the computing environment; and at block 36, causes display of the security posture visualization based on the output validation score.

### Example Methods

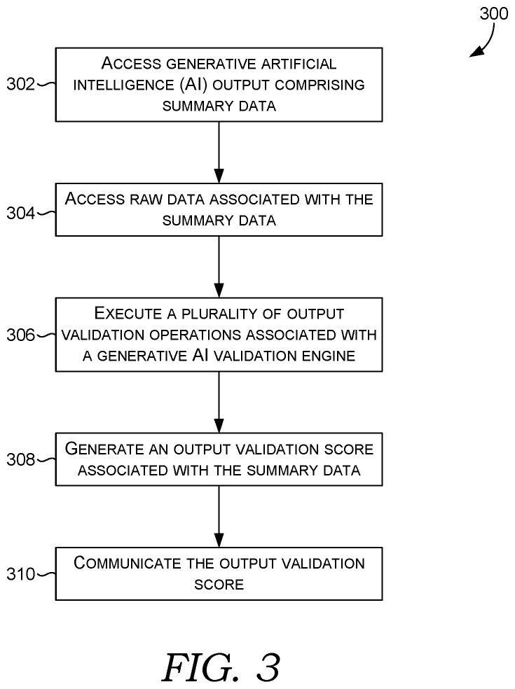

With reference to FIGS. 3, 4, and 5, flow diagrams are provided illustrating methods for providing generative AI output validation using a generative AI output validation engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system or computing system).

Turning to FIG. 3, a flow diagram is provided that illustrates a method 300 for providing generative AI output validation using a generative AI output validation engine in an artificial intelligence system. At block 302, access generative AI output comprising summary data. At block 304, access raw data associated with the summary data. At block 306, execute a plurality of output validation operations associated with a generative AI output validation engine. At block 308, generate an output validation score for each summary data. At block 310, communicate the output validation score.

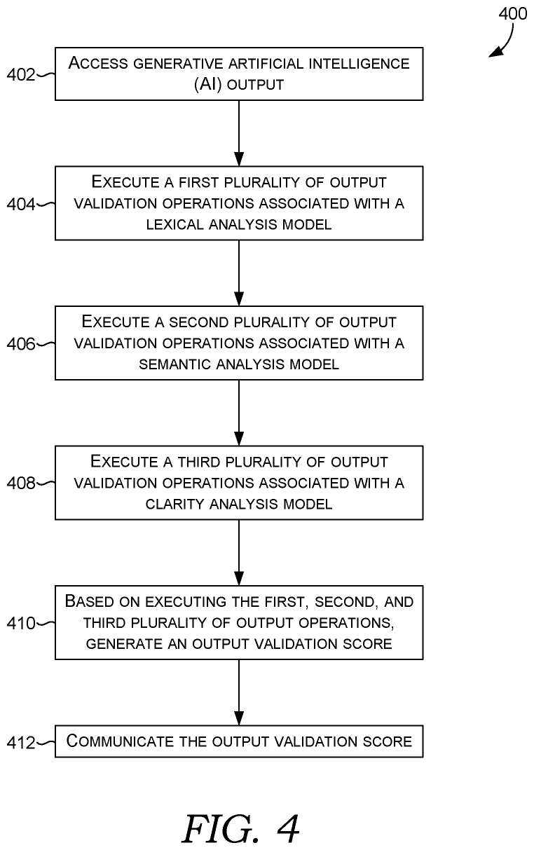

Turning to FIG. 4, a flow diagram is provided that illustrates a method 400 for providing generative AI output validation using a generative AI output validation engine in an artificial intelligence system. At block 402, access generative AI output. At block 404, execute a first plurality of output validation operations associated with a lexical analysis model. At block 406, execute a second plurality of output validation operations associated with a semantic analysis model. At block 408, execute a third plurality of output validation operations associated with a clarity analysis model. At block 410, based on executing the first plurality of output validation operations, the second plurality of output validation operations, and the third plurality of output validation operations, generate an output validation score. At block 412, communicate the output validation score.

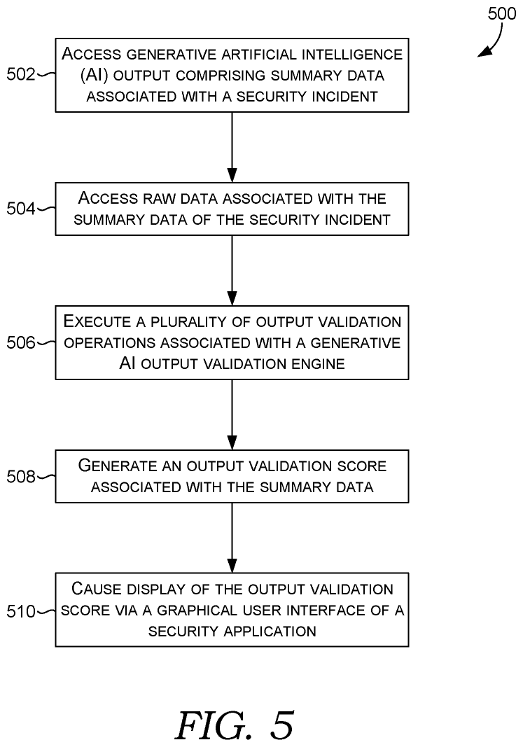

Turning to FIG. 5, a flow diagram is provided that illustrates a method 500 for providing generative AI output validation using a generative AI output validation engine in an artificial intelligence system. At block 502, access generative AI output comprising summary data associated with a security incident. At block 504, access raw data associated with the summary data of the security incident. At block 506, to compare the summary data and the raw data, execute a plurality of output validation operations associated with a generative AI output validation engine. At block 508, generate an output validation score associated with the summary data. At block 510, cause display of the output validation score via a graphical user interface of a security application.

### Technical Improvement

Embodiments of the present technical solution have been described with reference to several inventive features (e.g., operations, systems, engines, and components) associated with an artificial intelligence system. Inventive features described include: operations, interfaces, data structures, and arrangements of computing resources associated with providing the functionality described herein relative with reference to a generative AI output validation engine. Functionality of the embodiments of the present technical solution have further been described, by way of an implementation and anecdotal examples—to demonstrate that the operations (e.g., using multi-categorical analytical models—a lexical analysis model, a semantic analysis model, and a human-oriented clarity analysis model—that provide corresponding operations for quantifying quality of generative AI outputs). The generative AI output validation engine is a solution to a specific problem (e.g., lack of information evaluation metrics to evaluate generative AI outputs). The generative AI output validation engine improves computing operations associated with providing generative AI output validation using a generative AI output validation engine of an artificial intelligence system.

### Additional Support for Detailed Description

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing platform 610 in a data center can be configured to host and support operation of endpoints of a particular service application. Cloud computing platform 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 700 described with reference to FIG. 7, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 6 in particular, an example operating environment for implementing embodiments of the present technical solution is shown and designated generally as computing device 600. Computing device 600 is but one example of a suitable computing environment and is not intended to suggest any limitation as to the scope of use or functionality of the technical solution. Neither should computing device 700 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. AI so, processors have memory. We recognize that such is the nature of the art, and reiterate that the diagram of FIG. 7 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof.

Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. AI so, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive.

Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing generative artificial (AI) output comprising summary data;
accessing raw data associated with the summary data;
executing a plurality of output validation operations associated with a generative AI output validation engine, wherein the generative AI output validation engine comprises multi-categorical analytical models having corresponding operations for quantifying quality of generative AI outputs;
based on executing the plurality of output validation operations, generating an output validation score associated with the summary data; and
communicating the output validation score.

2. The system of claim 1, wherein the summary data comprises a summary of the raw data and a plurality of quality evaluation scores including a lexical analysis score, a semantic analysis score, and a clarity analysis score.

3. The system of claim 1, wherein the plurality of multi-categorical analytical models include a lexical analysis model, a semantic analysis model, and a clarity analysis model.

4. The system of claim 1, wherein executing the plurality of output validation operations comprises:
executing a first plurality of output validation operations associated with a lexical analysis model that supports comparing a lexical form of raw data to a lexical form of summary data;
executing a second plurality of output validation operations associated with a semantic analysis model that supports comparing a contextual analysis of raw data to summary data; and
executing a third plurality of output validation operations associated with a clarity analysis model that supports evaluating user trust and satisfaction based on a plurality of identified metrics.

5. The system of claim 1, wherein generating the output validation score is generated based on:
accessing a first final score associated with a lexical analysis model;
accessing a second final score associated with a semantic analysis model;
accessing a third final score associated with a clarity analysis model; and
generating the output validation score based on the first output validation score, the second output validation score, and the third output validation.

6. The system of claim 1, the operations further comprising:
receiving a request for security posture of a computing environment;
based on the request for the security posture of the computing environment, generating a security posture visualization associated with the output validation score; and
communicating the security posture visualization to cause display of the security posture visualization.

7. The system of claim 1, further comprising a customer feedback mechanism that supports presenting summary data to human validators for review and providing feedback on any discrepancies or errors, wherein the feedback is employed in refining the generative AI output validation engine.

8. One or more computer-storage media having computer-executable instructions embodied thereon that, when executed by a computing system having a processor and memory, cause the processor to perform operations, the operations comprising:
communicating a request for security posture of a computing environment;
based on the request for the security posture of the computing environment, accessing a security posture visualization associated with an output validation score, wherein the output validation score is generated using a generative AI output validation engine, the generative AI output validation engine comprises multi-categorical analytical models having corresponding operations for quantifying quality of generative AI outputs; and
causing display of the security posture visualization.

9. The media of claim 8, wherein the plurality of multi-categorical analytical models include a lexical analysis model, a semantic analysis model; and a clarity analysis model.

10. The media of claim 9, wherein the lexical analysis model employs a parts of speech tagger algorithm to support comparing a lexical form of raw data to a lexical form of summary data.

11. The media of claim 9, wherein the semantic analysis model employs a completeness determination algorithm to support comparing a contextual analysis of raw data to summary data.

12. The media of claim 9, wherein the clarity analysis model employs a user-trust and satisfaction evaluation algorithm to support evaluating user trust and satisfaction based on a plurality of identified metrics.

13. The media of claim 11, the operations further comprising:
receiving a request for security posture of a computing environment;
based on the request for the security posture of the computing environment, generating a security posture visualization associated with the output validation score; and
communicating the security posture visualization to cause display of the security posture visualization.

14. The media of claim 8, the operations further comprising:
communicating a request for security posture of a computing environment;
based on the request for the security posture of the computing environment, accessing a security posture visualization associated with the output validation score; and
causing display of the security posture visualization.

15. A computer-implemented method, the method comprising:
accessing generative artificial intelligence (AI) output associated with a generative AI model;
using a generative AI output validation engine, executing a plurality output validation operations associated with multi-categorical analytical models having corresponding operations for quantifying quality of generative AI outputs, wherein executing the plurality of output validation operations comprises:
executing a first plurality of output validation operations associated with a lexical analysis model;
executing a second plurality of output validation operations associated with a semantic analysis model; and
executing a third plurality of output validation operations associated with a clarity analysis model;
based on executing a plurality output validation operations, generating an output validation score; and
communicating the output validation score.

16. The method of claim 15, wherein the lexical analysis model of the multi-categorical analytical models employs a parts of speech tagger algorithm to support comparing a lexical form of raw data to a lexical form of summary data.

17. The method of claim 15, wherein the semantic analysis model of the multi-categorical analytical models employs a completeness determination algorithm to support comparing a contextual analysis of raw data to summary data.

18. The method of claim 15, wherein a clarity analysis model of the multi-categorical analytical models employs a user-trust and satisfaction evaluation algorithm to support evaluating user trust and satisfaction based on a plurality of identified metrics.

19. The method of claim 15, wherein generating the output validation score is generated based on:
accessing a first final score associated with a lexical analysis model;
accessing a second final score associated with a semantic analysis model;
accessing a third final score associated with a clarity analysis model; and
generating the output validation score based on the first final score, the second final score, and the third final score.

20. The method of claim 15, the method further comprises:
receiving a request for security posture of a computing environment;
based on the request for the security posture of the computing environment, generating a security posture visualization associated with the output validation score; and
communicating the security posture visualization to cause display of the security posture visualization.
